(19) United States
(12) Patent Application Publication
(10) Pub. No.: US 2014/0197850 A1
(43) Pub. Date: Jul. 17, 2014

(54) Piezoelectric Sensor for the Detection and Characterization of at Least One Biochemical Element

(71) Applicants: Stephane Serfaty, Acheres (FR); Pascal Griesmar, Courbevoie (FR); Jean-Yves Le Huerou, Montreuil (FR); Emmanuel Caplain, Nesles la Vallee (FR)

(72) Inventors: Stephane Serfaty, Acheres (FR); Pascal Griesmar, Courbevoie (FR); Jean-Yves Le Huerou, Montreuil (FR); Emmanuel Caplain, Nesles la Vallee (FR)

(73) Assignee: UNIVERSITE DE CERGY PONTOISE, Cergy-Pontoise (FR)

(21) Appl. No.: 14/126,094

(22) PCT Filed: Jun. 13, 2012
(86) PCT No.: PCT/FR2012/051323

§ 371 Date: Mar. 27, 2014

(30) Foreign Application Priority Data
Jun. 16, 2011 (FR) 1101881

(51) Int. Cl. G01N 27/02

(52) U.S. Cl. CPC G01N 27/023
USPC 324/655

(57) ABSTRACT

A piezoelectric sensor for the detection and characterization of at least one biochemical element in a fluid, has a piezoelectric substrate exhibiting at each of its opposite faces at least one conducting surface forming electrodes, the electrodes being linked to an electrical generator, one at least of the surfaces being wrapped in a functionalized film, the electrodes form transmission lines exhibiting a zone constituting an induction loop for the excitation of the piezoelectric substrate, the link between the electrodes and the generator being ensured by inductive coupling. A system implementing such a sensor, as well as applications of such a sensor, are described.

### BACKGROUND

1. Field of the Invention

The present invention concerns the field of the detection of biochemical elements, and more particularly detection by means of piezoelectric sensors.

2. Prior Art

The American patent U.S. Pat. No. 7,566,531 is known from the prior art, describing a biosensor comprising a quartz microbalance and a selective substrate film disposed on a surface of a conductive element of the quartz crystal microbalance. The selective substrate contains one or more connection sites that are connected covalently to the selective substrate film. This “selective substrate” is formed by a material that may be modified in order to contain connection sites appropriate for the fixing or association of cells, and which can be deposited or applied to a surface of a quartz microbalance: synthetic polymers (for example, or thiophenes, pyrrols, anilines, and derivatives thereof), biological polymers (for example peptides, nucleotides and carbohydrates), or composites formed from these materials. A “linking site” or “linking fraction” in or on the selective substrate on a quartz microbalance is a compound or a molecule, for example a peptide, that directs the specific linking of a cell, for example an epithilial cell. In one embodiment described in this patent, a cell is fixed to the selective substrate.

The European patent application EP 2017612 is also known, describing a biosensor for the detection of a marker in a sample. This biosensor of the prior art comprises a piezoelectric resonator mounted on a printed circuit card and connected to an oscillator. The sensor consists of two piezoelectric resonators in series, separated by a space. One of the resonators is the reference resonator and the other resonator has on the electrode surface a coating layer including a selective capture molecule.

There is also known in the prior art the article by N Wilkie-Chancellier et al “Novel shear-wave magneto-acoustic technique for the characterisation of viscous fluids” published on the occasion of the 10^{th} French Acoustic Congress on 16 Apr. 2010, pages 1-6 (http://cfa.sfa.assoc.fr/cdf.cdl/data/articles/000106.pdf).

The content of this document is incorporated in the present patent by reference.

This document concerns not a sensor intended for the characterisation of a biochemical element that is the subject matter of the invention, but a sensor for measuring viscoelastic properties of viscous fluids.

### DRAWBACKS OF THE KNOWN SOLUTIONS

The solutions of the prior art are not completely satisfactory since their discriminating ability is limited. The reason is that the sensors of the prior art allow only the measurement of variations of either mechanical or electrical origin on the piezoelectric substrate when it is in contact with a material to be analysed, by means of the selective film. These variations may have multiple origins, and measuring these variations does not constitute an unequivocal signature of the presence of a target agent interacting with the selective film.

A second drawback of the prior art concerns the cable link connecting the conductive electrodes disposed on the surface of the piezoelectric component to a periodic voltage source. This electrical connection requires the passage of a wire through the wall of a container for the material to be analysed.

Concerning the aforementioned article, it has the drawback of relating to the characterisation of a viscous medium coming into contact with the sensor, and therefore providing information on this viscous medium rather than on the elements that it contains. Moreover, it does not enable fluid media to be characterised. It is therefore not appropriate for characterising biochemical elements contained in a fluid.

### SUMMARY

In order to respond to the problem of the prior art, the invention proposes a solution consisting of providing the excitation of the piezoelectric sensor by an electromagnetic coupling rather than by an electrical coupling as proposed in the prior art.

This solution provides two independent types of information, corresponding firstly to the rheological properties and secondly to the electrical properties, by a single measurement. Omitting the cabled link moreover requires a radically novel design different from the electrodes of the prior art in order to provide electrical excitation of the piezoelectric substrate on the appropriate axis, for example along the AT cut.

It especially makes it possible, unlike some solutions of the prior art, to characterise elements contained in a medium, rather than the medium itself.

This solution makes it possible, according to a particular embodiment, to integrate the sensor in the wall of a reservoir and to couple at a distance in order to supply the sensor and analyse the signals.

To this end, the invention concerns, according to its most general meaning, a piezoelectric sensor for the detection and characterisation of at least one biochemical element in a fluid, consisting of a piezoelectric substrate exhibiting at each of its opposite faces at least one conducting surface, said electrodes being linked to an electrical generator, one at least of said surfaces being covered with a functionalised film. The invention is characterised by the fact that said conducting surfaces form transmission lines exhibiting a zone constituting an induction loop, said lines forming an electrode for the excitation of said piezoelectric substrate, the link between said conducting surfaces and said generator being provided by inductive coupling.

The sensor is formed by two electrodes formed by two circular conductive strips with several turns, formed in parallel planes separated by a low-loss dielectric.

The voltage-current equations of the transmission line and the characteristic impedance Z0, the resonance condition is then given by:

$$\frac{{L}_{tot} ω}{4 {Z}_{0}} tan ( \frac{ω \sqrt{ɛ} {l}_{m}}{4 c} ) = 1$$

where:
Lₜₒₜ is the equivalent inductance of the two-strip system,
the characteristic impedance of the transmission line Z₀
the dielectric constant ∈ of the substrate
the mean length lₘ of the line,
the speed c
and ω the resonance angular frequency.

This type of resonator has been used for producing high-field NMR antennas. A version in the form of a “pancake” makes it possible to produce a surface antenna. However, to use it at low frequency, the solution proposed is up until now adding a capacitor at the terminals of the slots.

To reduce the resonant frequency of such a circuit, the length of the line lₘ and the total inductance Lₜₒₜ can however be increased. From a practical point of view, this solution is obtained by increasing the number of turns on the line constituting the resonator.

Preferably, the mechanical resonant frequency of the piezoelectric substrate corresponds to the autoresonance frequency of the transmission line and said sensor is associated with unique means for measuring the electrical and mechanical properties of the piezoelectric substrate when it is excited.

Advantageously, the mechanical resonant frequency of the piezoelectric substrate is different from the autoresonance frequency of the transmission line and said sensor is associated with a means for simultaneously measuring mechanical properties at said first frequency and, at said second frequency, electrical properties of the piezoelectric substrate when it is excited.

According to a preferred embodiment, said functionalised film comprising at least one interaction element specific to at least one target on the one hand, and means of attaching said interaction elements on the surface of the piezoelectric substrate.

The invention also concerns a system for detecting and characterising at least one biochemical element in a fluid comprising a piezoelectric sensor and control equipment comprising a generator for exciting said sensor, characterised in that said generator supplies at least one induction loop interacting with said sensor, the equipment comprising in addition a circuit for the electrical processing of the signal resulting from said induction loop.

The invention also concerns applications of a sensor or system according to the invention for:
the predictive detection of the corrosion of metals, characterised in that the functionalised film is selective for at least one microorganism including the metal corrosion process;
the predictive detection of the degradation of mineral materials, characterised in that the functionalised film is selective for at least one microorganism inducing the process of degradation of said mineral materials;
the predictive detection of the degradation of organic materials, characterised in that the functionalised film is selective for at least one microorganism inducing the process of degradation of said organic materials;
the monitoring of circuits for the distribution of liquid, in particular water, characterised in that at least one sensor the functionalised film of which is selective for at least one microorganism is disposed in the stream of water;
the monitoring of liquid reservoirs, in particular for water or fuels, characterised in that at least one sensor the functionalised film of which is selective for at least one microorganism causing corrosion is disposed in said reservoir;
the monitoring of gas tanks, characterised in that at least one sensor the functionalised film of which is selective for at least one active agent is disposed in said tank;
the monitoring of an air-conditioning installation, characterised in that at least one sensor the functionalised film of which is selective for at least one microorganism is disposed in the heat-transfer fluid transport circuit;
diagnosis in health fields, characterised in that a biological sample is deposited on said functionalised film, said film being specific to a pathogen,
diagnosis in health fields, characterised in that a biological sample is deposited on said functionalised film, said film comprising a hybridisation probe;
diagnosis in health fields, characterised in that a biological sample is deposited on said functionalised film, said film being specific to a biological marker;
analysis of food products, characterised in that a sample is deposited on said functionalised film, said film being specific to an active agent;
analysis of cosmetic products, characterised in that a sample is deposited on said functionalised film, said film being specific to an active agent;
analysis of the amount of polysaccharide and/or ethanol in a reactor for producing ethanol from algae, with a view to maximising the production of ethanol.

### BRIEF DESCRIPTION OF THE DRAWINGS

The invention will be understood better from a reading of the following description referring to non-limitative example embodiments, illustrated by the accompanying drawings, where:

FIG. 1 shows an exploded view in cross section of a sensor according the invention

FIG. 2 shows a view of a typical structure of the shear-wave ultrasonic transduction part

FIG. 3 shows a general diagram of a biosensor according to the invention

FIG. 4 shows a general diagram of a recommended contactless measuring system

FIG. 5 shows the electrical diagram of the probe/sensor system with material present

FIG. 6 shows the table of characteristics of the fluids used, consisting of a mixture of glycerol in water

FIG. 7 shows the response curve of the probe/sensor pair for various proportions of glycerol in water

FIG. 8 shows the curve of the real part of the measured impedance after compensation for various proportions of glycerol in water as a function of the excitation frequency

FIG. 9 shows the curve for the difference in resonant frequency for various water/glycerol mixtures at 20° C.

### DETAILED DESCRIPTION

The architecture of the biosensor (usable in emission/reception) has the ability to generate and capture simultaneously ultrasonic and radio-frequency (RF) electromagnetic waves. Its sensitivity to the simultaneous changes in these waves passing through a functionalised biocompatible film confers on this biosensor increased selectivity and precision.

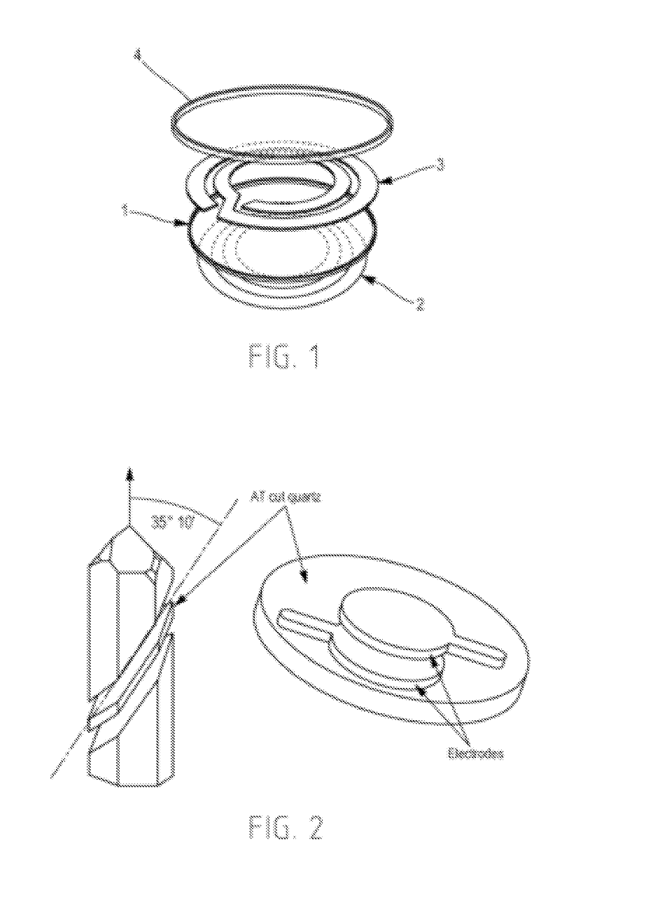

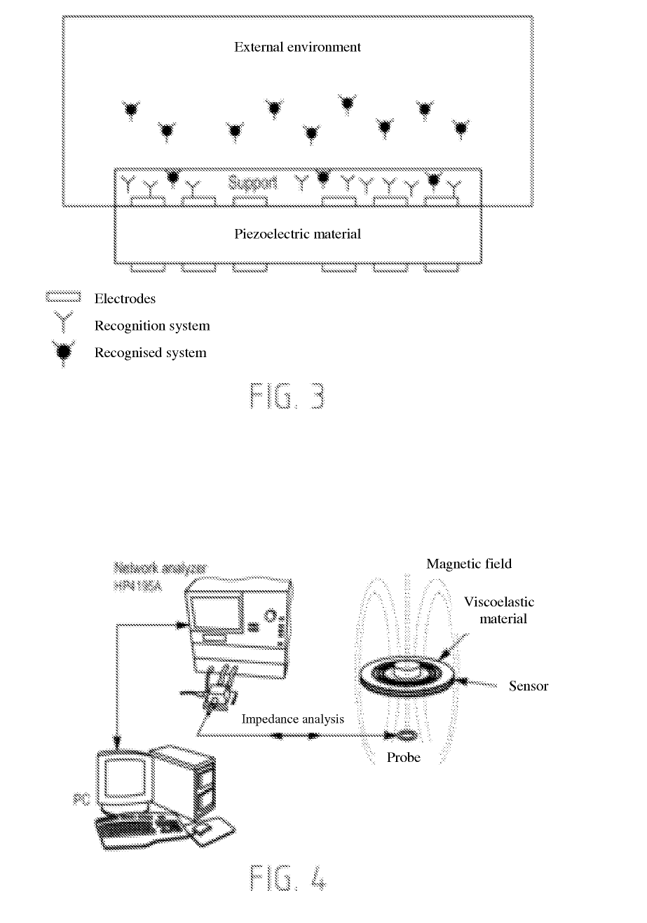

The biosensor shown in FIG. 1 consists of:
a piezoelectric substrate (1) providing an electrical-mechanical transduction generating an ultrasonic shear wave
an auto-resonant transmission line radiating an intense magnetic field, formed by two conductive tracks (2, 3)
a functionalised film (4), biocompatible and selective.

The conductive tracks (2, 3) are deposited on each of the discal principal faces, on the surface of the piezoelectric component (1). This component, discal in form in the example described, therefore separates two conductive surfaces (2, 3) forming the electrodes, the whole constituting an electrical capacitor. The piezoelectric transducer effect provides on the electrodes (2, 3) an electrical charge induced by the mechanical stresses undergone by the layer of piezoelectric material.

The electromechanical characteristics of this assembly are modified by the interactions of the functionalised film (4) with molecules, proteins or microorganisms (bacteria for example) liable to fixed selectively on this film, by adsorption on the molecular scale.

Alternatively, it is possible to use a piezoelectric membrane composed of a metal thin film, forming the base substrate of the membrane, and on which at least one layer of piezoelectric ceramic is fixed. The external face of the piezoelectric ceramic is metallised, in order to form a first electrode, the metal thin film forming a second electrode. In other cases, the membrane is composed of an electrically insulating thin film, on which at least one layer of piezoelectric ceramic is fixed, the two faces of which are metallised and constitute the electrodes.

The electrodes (2, 3) take the form of two coplanar helical turns.

The sensor is excited by a weakly coupled circular probe. This probe is advantageously used also for measuring the response of the sensor by inductive coupling.

The transmission line produced approaches a radio-frequency sensor with a surface developed for imaging the skin by NMR.

Its flat architecture enables:
producing an auto-resonant transmission line radiating an intense RF magnetic field,
a strong coefficient of quality and a contactless symmetrical induction since it uses no tuning capacitor,
confining the radio-frequency magnetic field at the surface of the sensor.

So that this sensor can generate shear waves, the dielectric substrate (1) that separates the two electrodes (2, 3) must also be piezoelectric.

The resonant frequency is determined in a known manner according to the configuration of the electrodes (2, 3) and the dielectric substrate (1).

By way of example, here are a few example embodiments:

For a resonant frequency of 11.16 MHz, each of the electrodes (2, 3) has two turns, with an outside diameter of 163 millimetres. The tracks have a width of 10 millimetres and are spaced apart by an air gap of one millimetre. The substrate has a dielectric constant of 4.1 and thickness of 0.61 millimetres.

For a resonant frequency of 7.44 MHz, each of the electrodes (2, 3) has two turns, with an outside diameter of 163 millimetres. The tracks have a width of 10 millimetres and are spaced apart by an air gap of one millimetre. The substrate has a dielectric constant of 4.1 and thickness of 0.61 millimetres.

For a resonant frequency of 5.79 MHz, each of the electrodes (2, 3) has two turns, with an outside diameter of 163 millimetres. The tracks have a width of 10 millimetres and are spaced apart by an air gap of one millimetre. The substrate has a dielectric constant of 4.1 and thickness of 0.61 millimetres.

For a resonant frequency of 9.14 MHz, each of the electrodes (2, 3) has two turns, with an outside diameter of 163 millimetres. The tracks have a width of 11 millimetres and are spaced apart by an air gap of 0.65 millimetres. The substrate has a dielectric constant of 4.1 and thickness of 1.55 millimetres.

For a resonant frequency of 7.23 MHz, each of the electrodes (2, 3) has six turns, with an outside diameter of 134 millimetres. The tracks have a width of 4 millimetres and are spaced apart by an air gap of 0.5 millimetre. The substrate has a dielectric constant of 4.1 and thickness of 1.55 millimetres.

According to its piezoelectric properties, its crystalline orientation, the form of the electrodes (2, 3) on the surfaces opposite to the substrate, and the electromagnetic field applied between the electrodes, the deformation mode of the substrate (1) is completely controlled. In order best to exploit these properties and the performances of the sensor, the thickness of the substrate is chosen so as to make the substrate resonate mechanically at the required frequency, which may or may not coincide with the resonant frequency of the RF transmission line according to the application required. FIG. 2 shows the example of a quartz piezoelectric substrate with an AT cut (35° 10′), ensuring the generation of shear waves when an electrical field is applied between the two electrodes (2, 3), and resonant stability in terms of temperature.

The conditions at the limits of the propagation of the mechanical waves defining the resonance conditions are derived conventionally by the constituent piezoelectricity equations. Using suitable electrical models (derived either from Masson or Butterworth-Van Dyke), it is possible to go back to the rheological properties of a complex fluid in contact.

For analysing a yogurt under formation, for example, a typical sensor is used (without RF transmission line) resonant mechanically at 6 MHz (piezoelectric disc (substrate) between 15 and 20 millimetres diameter, 270 μm thick, electrodes 5 millimetres in diameter).

Detecting an active molecule in a fluid requires being able to attract this molecule preferentially in the vicinity of the sensor and causing an interaction before the functionalised film (4) able to modify the electromechanical behaviour of the resonant assembly formed by the piezoelectric component (1) and the electrodes (2, 3).

This specificity involves a modification of the surface of the sensor in order to increase the sensitivity thereof. One of the consequences sought is to make the detection of a chemical or biological molecule more precise in order to be able, for example in the case of a chemical or biological pollution, to act on the medium to be studied in order to limit the consequences for example for health, or to anticipate chemical or bacterial corrosions causing degradation of the storage material.

In order to be able to produce a biosensor for the in situ detection of chemical or biological species in real time, the production of a material having required specific properties from molecular precursors in a “bottom up” approach can be envisaged.

The molecular precursors may be of organic and/or inorganic origin. These precursors must be associated by means of soft-chemistry methods, that is to say by polymerisation methods at a temperature close to ambient in order to preserve the functionality of organic groups inserted or grafted on these precursors. It is therefore done by polymerisation methods that are purely inorganic or organic-inorganic hybrid by sol-gel method.

By means of concerted hydrolysis-condensation reactions the sol-gel (SG) method enables the formation of an oxide lattice in solution (aqueous or organic). It is achieved by polymerisation of inorganic precursors, without passing through the fusion step at temperatures close to ambient. These precursors are in general alkoxides of formula M(OR)ₙ, where M is usually silicon (metalloid) or a transition metal (titanium, zirconium, etc), and R an alkyl group. In the case of precursors based on silicon alkoxide, it is preferentially possible to start from a precursor of the R′Si(OR)₃ or R′R″Si(OR)₂ type where R′ and R″ represent specific organic groups.

These materials, between the solution and the solid, pass through intermediate states consisting of colloids forming sols or gels. Starting from a sol, it is possible to control the final properties of the gels obtained by acting on the chemical and/or physical parameters.

The use of aqueous or organic solvents during synthesis makes it possible to envisage the manufacture of organic-inorganic hybrid materials, that is to say the formation of two lattices, having different physicochemical properties, in the same gel. These hybrid materials aim to combine the strength and stability that can be afforded by their inorganic component with the many specific properties generated by the organic component. These lattices may be associated in two ways: either by weak bonds (class I) or by covalent bonds (class II).

The conditions for producing these materials make it possible to produce materials having specific properties and then of organic copolymers having a chemical or biological function. The objective of the grafting of this function is to develop an innovative material for example for the encapsulation of biological entities such as bacteria. These materials may in this example constitute the organic part of a hybrid material with a view to producing a biosensor.

Their interactions with the hybrid material cause modifications to its electrical and mechanical properties. These modifications are consequently detected by the transducer part presented previously.

The general principle of the biosensor is the use of a sol-gel matrix. After having formed this matrix, biologically active molecules are inserted (directly or indirectly), which will enable a specific recognition of another biological entity. It is associated with an electrical and/or mechanical detection mode making it then possible to determine and/or quantify the presence of this entity. The object is therefore to produce a hybrid organic-inorganic sol-gel matrix, where antibodies are for example fixed on the gold electrodes of the resonant sensor.

To achieve the deposition of the sol-gel matrix on the gold electrode, the latter must previously be immersed in a solution of hydrolysed inorganic precursor. The precursor generally used is MPTS since this has thiol functions then enabling the grafting of the surface nanoparticles on the matrix.

To enable the bio-encapsulation of bacteria on the sol-gel matrix, it is necessary for the latter to promote the biomolecule-matrix interactions. It is therefore advantageous to envisage the insertion/grafting of molecules facilitating these interactions on the SG material.

The grafting of amino acids on the organic lattice appears to be a good solution for creating an optimum environment for the bio-encapsulation of bacteria. It is more simple to produce a “polymerisable” amino acid providing the formation of the lattice by reaction with a crosslinking agent. It is also possible to form directly an inorganic lattice from a precursor having a functionality of the “amino acid” type. Another solution for improving the biomolecule-matrix interactions is to use, for example, sugars promoting encapsulation.

### Example

### Grafting of Amino Acids on a Polymer Matrix

In organic-inorganic hybrid materials, the organic lattice usually consists of a crosslinked polymer on which it is possible for example to graft amino acids (for example mono-, di- and tri-peptides on a copolymer).

The grafting can be carried out by the a priori synthesis of a copolymer. It is possible to use three different amino acids: alanine (R═-Me), glycine (R═—H) and serine (R═—CH₂—OHJ).

The polymer can be produced by copolymerisation of acrylic acid (AAc) with N-isopropylacrylamide (NIPAM) using a radical initiator (azobisisobutyronitrile), in dimethylformamide (DMF). It is purified by double precipitation in diethlyl ether; then dried in an oven.

The sensor is excited by a probe, circular and weakly coupled. This probe is also used for measuring the response of the sensor. In the case of a weak coupling between the probe and the sensor, their interactions are dependent on the surface of the probe and the magnetic field induced on excitation current quadratic ratio (in the probe). The modifications to the magnetic field caused by the sensor put close to the probe then involved by reciprocity modifications to the properties of the probe. A measurement of impedance, seen from the input of the probe, makes it possible, in this case, to characterise the sensor in the presence or not of the material.

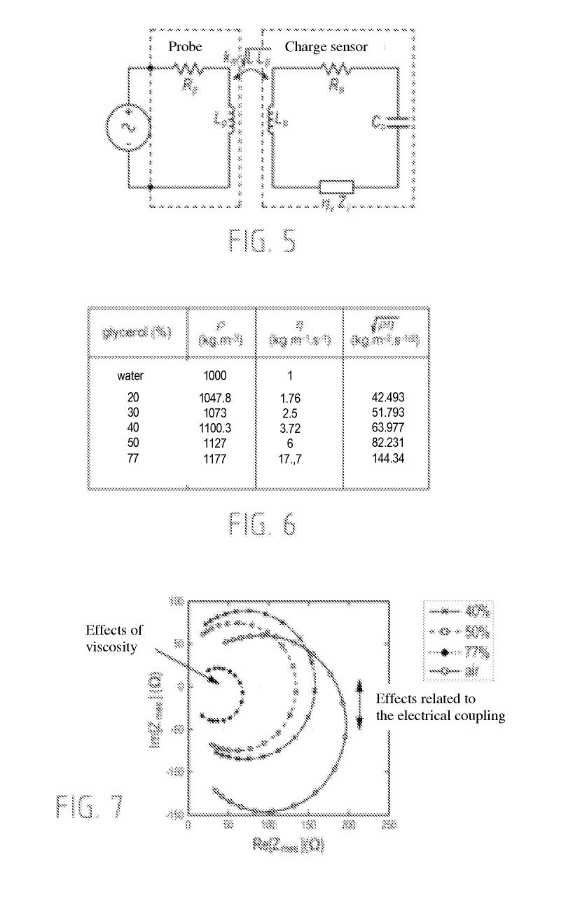

The interactions of the probe/sensor pair are purely inductive. The coupling between the probe and the sensor can therefore be represented by a transformer, with a coupling coefficient kₘ, the primary of which is the probe (inductance with losses) and the secondary of which is the sensor charged by the viscoelastic material or not. The equivalent diagram of the “probe/charged sensor” assembly is represented by FIG. 5.

The impedance seen at the input is the given by:

$${Z}_{s} = {Z}_{p} + \frac{{M}^{2} {ω}^{2}}{{Z}_{s} + {η}_{p} {Z}_{i}} \qquad ( 1 )$$

where Zₚ is the equivalent impendance of the probe, Zₛ is the impedance of the sensor (offload) and M the mutual inductance between the probe and the sensor. The equivalent elements Lₛ, Cₛ and Rₛ are respectively the inductance, the capacitor and the intrinsic resistance of the offload sensor. Zᵢ represents the effects related to the material deposited on the piezoelectric of the sensor.

In this configuarion, the change in the response of the sensor in the presence of the material does not suffice to determine the mechanical properties of the medium. The material being weakly conductive, it is necessary to distinguish the magnetic energy created in the space of the medium studied, from the magnetic energy created outside the space. The filling coefficient ηᵥ (ηᵥ<1) makes it possible to quanitify this concept. It takes account of the current induced in the material in the presence of the magnetic field. Considering that the electrical properties and the volume of the material studied are constant, it is then possible to link ηᵥ Zᵢ to the viscoelastic and electrical properties.

In order to go back to the mechanical properties of the material in contact with the magneto-acoustic sensor, it is possible to describe the link between the electrical impedance of the sensor under load (in the presence of the material) and the mechanical impedance. On the contact surface, this impedance is expressed by the ratio between the force applied and the speed of movement at the electrode. This explains, in a certain way, that the resonance conditions of the sensor are modified by the characteristics of the material in contact. A macroscopic description of the interactions makes it possible to distinguish two effects: an inertia effect that is described by Sauerbrey for the quartz microbalance charged by a perfectly rigid thin film, and an effect related to the viscoelastic properties of the material in contact. This effect is measurable under sinusoidal stressing of the sensor in contact with the viscoelastic material. If account is taken only of the effects related to the propagation of the ultrasonic wave thus generated, the mechanical impedance at the surface of the electrode is then that of the characteristic impedance of the material, that is to say:

Zₘ=\sqrt{ρₘₐₜG*(ω)} (2)

where ρₘₐₜ is the density of the material in contact.

In the case of a Newtonian fluid (liquid only viscous), G*(ω) depends only on the dynamic viscosity η and the excitation frequency. The real and imaginary parts of the characteristic impedance are then equal and become proportional to:

$${Z}_{m} = \sqrt{\frac{{ρ}_{mat} ω η}{2}} ( 1 + j ) \qquad ( 3 )$$

The charge can then be modelled, from an electrical point of view, by a resistor in series with an inductor. This equation therefore presages a reduction in the coefficient of quality of the resonator and a shift in the resonant frequency when the piezoelectric element is charged by a liquid. In accordance with the expression frequently used and described by Kanazawa and Gordon for quartz microbalances the shift in the resonant frequency, in the case of lightly viscous fluids, should therefore be written:

Δf≈K\sqrt{ρₘₐₜₑᵣᵢₐₗη} (4)

The description that follows concerns the qualitative assessment of the change in response of the sensor according to the viscosity. A series of validation measurements was carried out when the magneto-acoustic sensor was charged by a water-glycerol mixture with a controlled concentration of glycerol (between 0% and 80% glycerol in water). The characteristics of these water-glycerol mixtures (density and dynamic viscosity) are perfectly known and tabulated. The following table sets out the mechanical characteristics of the fluids at 20° C. In addition, their electrical property remains constant for a given temperature.

A systematic measurement of the electrical impedance at the terminals of the probe was carried out by depositing, at the sensor with RF transmission line using a PVDF piezoelectric, 150 μl of mixture at 20° C.

Its architecture made it possible to adjust the electromagnetic resonant frequency to 40 MHz and to provide the electrical/mechanical transduction. Because of the distribution of the electrical fields in the substrate during the sinusoidal excitation of the sensor, the movement generated at the centre of the loop is a shearing movement.

In order to measure only the effect on the sensor, an operation of compensation for the impedance of the probe Zₚ is first carried out. According to equation 2, this operation enables us to measure the following impedance:

$${Z}_{meas} = \frac{{M}^{2} {ω}^{2}}{{Z}_{s} + {η}_{V} {Z}_{i}} \qquad ( 5 )$$

FIG. 7 shows, in a complex plane, the electrical impedance measured at the terminal of the probe (after compensation) for various fluids.

Whatever the percentage of glycerol in water, the response of the sensor/probe pair is faithful to the response normally obtained for a resonator. In the complex plane, the measurements around the resonance of the sensor constitute in fact circles the centre and radius of which change according to the electrical coupling and the mechanical properties. The fluids used having a constant conductivity close to that of water, it is possible to clearly distinguish that the effects related to the electrical coupling cause a vertical modification of the centre of the circle. On the other hand, a change in viscosity of the fluid deposited causes essentially a reduction in the radius of the circle.

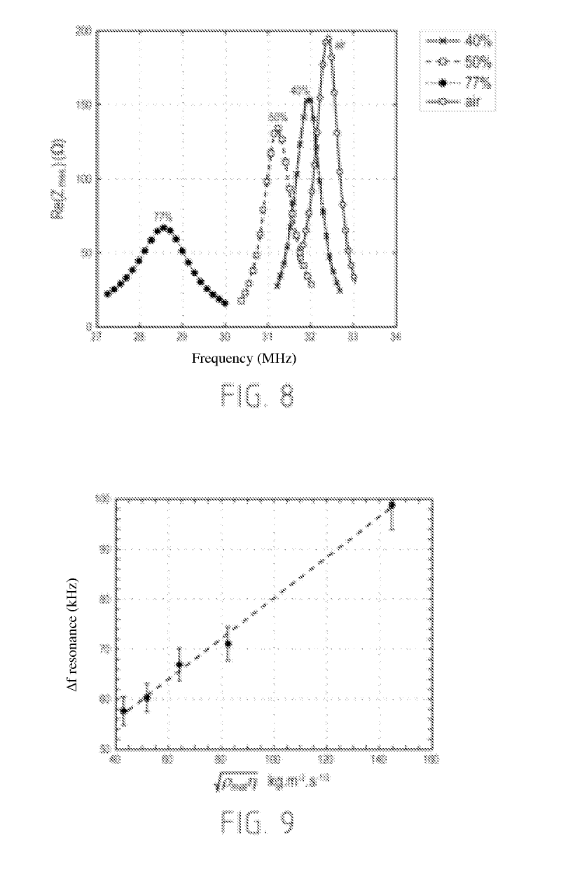

Since the fluids deposited on the PVDF are Newtonian, the measurement of the real part of the impedance suffices to extract the effect of the viscosity on the variation in frequency and on the losses of the resonator (see FIG. 8).

It should be noted that, since the density changes very slightly according to the concentration of glycerol (maximum difference 17%), the induced resistance of the sensor is especially affected by the variation in viscosity. This finding can be observed in FIG. 6 with regard to the reduction in the amplitude and the increase in the width of the resonance peaks. The increase in viscosity.

FIG. 9 shows the variations observed in the resonant frequency of the sensor when it is charged by 150 μl of water-glycerol mixtures at controlled viscosities.

The biosensor as described concerns in particular an application of early detection of corrosion, for organising preventive maintenance. The biosensor is located in the drain plug below aircraft tanks, for recovering the condensation water that is deposited at the bottom of the tank and which stagnates.

The sensor according to the invention is treated with a functionalised layer specific to the fungi and bacteria involved in corrosion. The detection of the proliferation of the biofilm provides information by measuring impedance on the appearance of corrosion caused by the acidic discharges of the bacteria.

The sensor is replaced in the event of formation of a biofilm, or cleaned manually or automatically.

The processing of the signal delivered by the biosensor takes place with respect to the “water” reference. One variant consists of providing one reference sensor on the mechanical aspect and another on the electrical aspect. An analysis of the frequency shift is carried out with a circuit comprising an operational amplifier and a coupler (incident wave/reflected wave separator) as well as a comparator between the two waves.

The change in the sensor is analysed with a theoretical reference or a sealed reference sensor.

A periodic recording is carried out by RFID in order to carry out predictive maintenance and to proceed with remote detection for buried structure parts.

1-19. (canceled)

20. A piezoelectric sensor for the detection and characterization of at least one biochemical element in a fluid, consisting of a piezoelectric substrate exhibiting at each of its opposite faces at least one conducting surface forming electrodes, said electrodes being linked to an electrical generator, at least one of said opposite faces being covered with a functionalized film, said electrodes forming transmission lines exhibiting a zone constituting an induction loop for an excitation of said piezoelectric substrate, and a link between said electrodes and said electrical generator being ensured by inductive coupling.

21. The piezoelectric sensor according to claim 20, wherein the dimensions Lₜₒₜ and lₘ of said transmission lines are determined by the formula:
$$\frac{{L}_{tot} ω}{4 {Z}_{0}} tan ( \frac{ω \sqrt{ɛ} {l}_{m}}{4 c} ) = 1$$
where:
Lₜₒₜ designates an equivalent inductance of a two-electrode system,
Z₀ designates a characteristic impedance of the transmission line,
∈ designates a dieletric constant of the piezoelectric substrate,
lₘ designates a mean length of a line,
c designates a speed, and
ω designates a resonance angular frequency.

22. The piezoelectric sensor according to claim 20, wherein a mechanical resonant frequency of the piezoelectric substrate corresponds to an autoresonant frequency of one of the transmission lines and said piezoelectric sensor is associated with unique means for measuring electrical and mechanical properties of the piezoelectric substrate when said piezoelectric substrate is excited.

23. The piezoelectric sensor according to claim 20, wherein a mechanical resonant frequency of the piezoelectric substrate is different from an autoresonant frequency of one of the transmission lines and said piezoelectric sensor is associated with a means for simultaneously measuring mechanical properties at a first frequency and, at a second frequency, electrical properties of the piezoelectric substrate when said piezoelectric substrate is excited.

24. The piezoelectric sensor according to claim 20, wherein said functionalized film comprises at least one interaction element specific to at least one target, and means for attaching said at least one interaction element on a surface of the piezoelectric substrate.

25. A system for detecting and characterising at least one biochemical element in a fluid comprising a piezoelectric sensor and control equipment comprising a generator for exciting said piezoelectric sensor, said generator supplying at least one induction loop interacting with said piezoelectic sensor, and the control equipment comprising a circuit for electrical processing of a signal resulting from said at least one induction loop.

26. The sensor according to claim 20 for the predictive detection of the corrosion of metals, wherein the functionalized film is selective for at least one microorganism inducing a process of corrosion of metals.

27. The sensor according to claim 20 for the predictive detection of the degradation of mineral materials, wherein the functionalized film is selective for at least one microorganism inducing a process of degradation of said mineral materials.

28. The sensor according to claim 20 for the predictive detection of the degradation of organic materials, wherein the functionalized film is selective for at least one microorganism inducing a process of degradation of said organic materials.

29. The sensor according to claim 20 for the monitoring of circuits for the distribution of water, wherein the functionalized film of said sensor being selective for at least one microorganism disposed in a stream of said water.

30. The sensor according to claim 20 for the monitoring of a liquid reservoir, wherein the functionalized film of said sensor is selective for at least one microorganism causing corrosion disposed in said reservoir.

31. The sensor according to claim 20 for the monitoring of gas tanks, the functionalized film of said sensor being selective for at least one active agent disposed in said tank.

32. The sensor according to claim 20 for the monitoring of an air-conditioning installation, wherein the functionalized film of said sensor is selective for at least one microorganism disposed in a heat-transfer fluid transport circuit.

33. The sensor according to claim 20 for diagnosis in health fields, wherein a biological sample is deposited on said functionalized film, and said functionalized film being specific to a pathogen.

34. The sensor according to claim 20 for diagnosis in health fields, wherein a biological sample is deposited on said functionalized film, and said functionalized film comprising a hybridization probe.

35. The sensor according to claim 20 for diagnosis in health fields, wherein a biological sample is deposited on said functionalized film, and said functionalized film being specific to a biological marker.

36. The sensor according to claim 20 for the analysis of food products, wherein a sample is deposited on said functionalized film, and said functionalized film being specific to an active agent.

37. The sensor according to claim 20 for the analysis of cosmetic products, wherein a sample is deposited on said functionalized film, and said functionalized film being specific to an active agent.

38. The sensor according to claim 20 wherein said sensor analyzes an amount of polysaccharide and/or ethanol in a reactor for producing ethanol from algae, to maximize the production of said ethanol.
